(19) United States
(12) Patent Application Publication
(10) Pub. No.: US 2012/0268601 A1
(43) Pub. Date: Oct. 25, 2012

(54) METHOD OF RECORDING TRAFFIC IMAGES AND A DRIVE RECORDER SYSTEM

(75) Inventors: Kuan-Hung YEH, Taipei City (TW); Shun-Cheng HUNG, Taipei City (TW)

(73) Assignee: Mitac International Corp., Gueishan Township (TW)

(21) Appl. No.: 13/453,443

(22) Filed: Apr. 23, 2012

(30) Foreign Application Priority Data
Apr. 25, 2011 (TW) 100114264

(51) Int. Cl. H04N 7/18

(52) U.S. Cl. 348/148; 348/E07.085

(57) ABSTRACT

A method of recording traffic images is to be implemented in a drive recorder system. The method includes recording the traffic images at a first recording frame rate, generating a detection signal according to movement of the vehicle, searching a pre-stored table to acquire a vehicle driving condition matching with the detection signal, and recording the traffic images at a second recording frame rate when the acquired vehicle driving condition corresponds to an alert condition. The second recording frame rate is greater than the first recording frame rate.

### CROSS-REFERENCE TO RELATED APPLICATION

This application claims priority of Taiwanese Application No. 100114264, filed on Apr. 25, 2011.

### BACKGROUND OF THE INVENTION

1. Field of the Invention

The invention relates to a drive recorder system and an image recording method thereof, more particularly to a drive recorder system and a method of dynamically adjusting a recording frame rate.

2. Description of the Related Art

It has become a trend to install a drive recorder in a vehicle so that accident events may be recorded. Taiwan Patent Publication No. M316827 discloses recording traffic images for a period of time upon detecting that acceleration is higher than a predetermined value. Taiwanese Patent Application Publication No. 200706839 discloses control of a steering device to steer in a first direction and use of an image capturing unit to record traffic images for a period of time when an accident event is detected.

Users generally choose a lower recording frame rate to save storage space when images are recorded for a long period of time during driving. However, since vehicular accidents usually occur at high speeds or within a short amount of time, and since reconstruction of an accident normally requires slow motion playback, the lower frame recording rate may not be adequate to obtain a satisfactory reconstruction of the accident.

### SUMMARY OF THE INVENTION

Therefore, an object of the present invention is to provide a method of recording traffic images that enables a change in the recording frame rate when a detected vehicle driving condition corresponds to an alert condition.

Another object of the present invention is to provide a drive recorder system that is capable of recording traffic images at a first recording frame rate under normal vehicle driving conditions, and at a second recording frame rate greater than the first recording frame rate under alert vehicle driving conditions.

According to a first aspect of the present invention, a method of recording traffic images is to be implemented in a drive recorder system and includes: recording the traffic images at a first recording frame rate; generating a detection signal according to movement of the vehicle; searching a pre-stored table to acquire a vehicle driving condition matching with the detection signal; and recording the traffic images at a second recording frame rate when the acquired vehicle driving condition corresponds to an alert condition. The second recording frame rate is greater than the first recording frame rate.

Preferably, the step of generating the detection signal includes: performing computation upon the movement of the vehicle to obtain a motion value; and performing motion detection computation upon the motion value to obtain the detection signal.

Preferably, the method of recording traffic images of this invention further includes the step of deactivating the recording of the traffic images by the drive recorder system when the motion value is lower than a minimum value for a first predetermined period of time.

Preferably, the method of recording traffic images of this invention further includes the step of activating the recording of the traffic images by the drive recorder system when the motion value is higher than the minimum value for a second predetermined period of time.

Preferably, the step of generating the detection signal includes: receiving a global positioning system (GPS) signal; and performing a comparison computation upon the GPS signal to obtain the detection signal.

Preferably, the step of performing the comparison computation upon the GPS signal includes: performing the comparison computation upon the GPS signal and map data to acquire a current position; and generating the detection signal when the current position is located on or adjacent to at least one road.

Preferably, the at least one road is an accident-prone road or a road where a speed limit is easily exceeded.

Preferably, the step of performing the comparison computation upon the GPS signal includes: performing the comparison computation upon the GPS signal and map data to acquire a current position; and generating the detection signal when the current position is located at or adjacent to an intersection.

According to a second aspect of the present invention, a drive recorder system for use in a vehicle includes:
an image capturing unit configured to record traffic images at a first recording frame rate when the drive recorder system is switched from a deactivated state to an activated state;
a motion sensing unit for generating a motion value according to movement of the vehicle;
a storage unit for storing a pre-stored table that defines relationships between a plurality of detection signals and a plurality of vehicle driving conditions that respectively match with the detection signals; and
a processing unit coupled electrically to the image capturing unit, the motion sensing unit, and the storage unit.

The processing unit is configured to receive the motion value from the motion sensing unit, to perform motion detection computation upon the motion value to obtain a computed detection signal, to acquire, from the pre-stored table, one of the vehicle driving conditions that matches with the computed detection signal, and to activate the recording of the traffic images at a second recording frame rate when the acquired vehicle driving condition corresponds to an alert condition. The second recording frame rate is greater than the first recording frame rate.

Preferably, the drive recorder system of this invention further includes a power supply unit coupled electrically to the processing unit. When the motion value is lower than a minimum value for a first predetermined period of time, the processing unit is operable to send a power off signal to the power supply unit, and the power supply unit is responsive to the power off signal to cut-off supply of electric power for deactivating the recording of the traffic images by the image capturing unit.

Preferably, when the motion value is higher than the minimum value for a second predetermined period of time, the processing unit is operable to send a power on signal to the power supply unit, and the power supply unit is responsive to the power on signal to resume supply of electric power for activating the recording of the traffic images by the image capturing unit.

According to a third aspect of the present invention, a drive recorder system for use in a vehicle includes:
an image capturing unit configured to record traffic images at a first recording frame rate when the drive recorder system is switched from a deactivated state to an activated state;
an antenna unit operable to receive a global positioning system (GPS) signal;
a storage unit for storing a pre-stored table that defines relationships between a plurality of detection signals and a plurality of vehicle driving conditions that respectively match with the detection signals, the storage unit further storing map data; and
a processing unit coupled electrically to the image capturing unit, the motion sensing unit, and the storage unit.

The processing unit is configured to receive the GPS signal from the antenna unit, to perform a comparison computation upon the GPS signal and the map data stored in the storage unit to acquire a current position, to generate a detection signal when the current position is located on or adjacent to at least one road, to acquire, from the pre-stored table, one of the vehicle driving conditions that matches with the generated detection signal, and to activate the recording of the traffic images at a second recording frame rate when the acquired vehicle driving condition corresponds to an alert condition. The second recording frame rate is greater than the first recording frame rate.

Preferably, the at least one road is an accident-prone road or a road where a speed limit is easily exceeded.

Preferably, the detection signal is generated when the current position is located at or adjacent to an intersection.

According to this invention, the recording frame rate is increased when the vehicle driving condition corresponds to an alert condition so that a satisfactory reconstruction of a vehicular accident is possible.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a preferred embodiment of a drive recorder system of the present invention; and

FIG. 2 is a flowchart illustrating a preferred embodiment of a method of recording traffic images to be implemented in a drive recorder system of the present invention.

### DETAILED DESCRIPTION OF THE PREFERRED EMBODIMENT

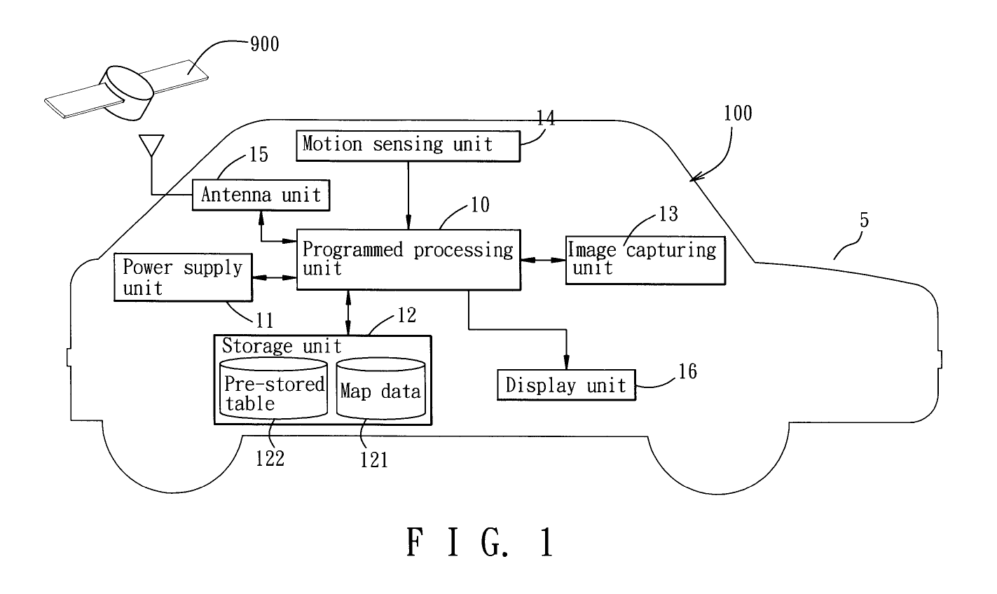

Referring to FIG. 1, the preferred embodiment of a drive recorder system 100 of the present invention is to be installed in a vehicle 5. In this embodiment, the drive recorder system 100 includes a power supply unit 11, a storage unit 12, an image capturing unit 13, a motion sensing unit 14, an antenna unit 15, a display unit 16, and a programmed processing unit 10 (e.g., a central processing unit or CPU) coupled electrically to each of the units 11-16.

The image capturing unit 13, such as a charge-coupled device (CCD) camera, is configured to record traffic images at a first recording frame rate when the drive recorder system 100 is switched from a deactivated state to an activated state.

The motion sensing unit 14 is operable to generate a motion value according to movement of the vehicle 5. The motion sensing unit 14 may be a gyroscope, an accelerometer, or an electronic compass. For example, when the motion sensing unit 14 is a gyroscope or an electronic compass, an angle value representing moving direction of the vehicle 5 is generated by the motion sensing unit 14, and the angle value (which serves as a motion value) is provided to the processing unit 10. The processing unit 10 performs motion detection computation upon the angle value to obtain a detection signal. In this embodiment, the motion detection computation involves computing the angle values received over a period of time to determine a current moving condition. For example, if the angle values increase from 0 degree over a period of time, this means that the vehicle 5 has started to move. A large change in the angle values means that the vehicle 5 is making a turn. On the other hand, if no change in the angle values occurs for a period of time, this means that the vehicle 5 has stopped moving. Likewise, the accelerometer is operable to detect speed changes in different axes, and can generate the motion value representing speed changes in different directions.

The storage unit 12 stores a pre-stored table 122 that defines relationships between a plurality of detection signals and a plurality of vehicle driving conditions that respectively match with the detection signals. In this embodiment, the storage unit 12 further stores map data 121, i.e., electronic map data of various roads. The vehicle driving conditions may be associated with vehicle movement or road conditions. The storage unit 12 may be an electrically erasable programmable read-only memory (EEPROM) or a removable secure digital card (SD card).

From the pre-stored table 122 of the storage unit 12, the processing unit 10 is operable to acquire one of the vehicle driving conditions that matches with the computed detection signal. Then, the processing unit 10 is operable to activate the recording of the traffic images of the image capturing unit 13 at a second recording frame rate when the acquired vehicle driving condition corresponds to an alert condition. By setting the second recording frame rate to be greater than the first recording frame rate, satisfactory reconstruction of a vehicular accident is possible. Furthermore, since traffic images are recorded at the first recording frame rate under normal vehicle driving conditions, storage space utilization may be optimized.

When the motion value is lower than a minimum value for a first predetermined period of time, the processing unit 10 is operable to send a power off signal to the power supply unit 11, and the power supply unit 11 is responsive to the power off signal to cut-off supply of electric power for deactivating the recording of the traffic images by the image capturing unit 13. On the other hand, when the motion value is higher than the minimum value for a second predetermined period of time, the processing unit 10 is operable to send a power on signal to the power supply unit 11, and the power supply unit 11 is responsive to the power on signal to resume supply of electric power for activating the recording of the traffic images by the image capturing unit 13.

The antenna unit 15 is operable to receive a global positioning system (GPS) signal from a GPS satellite 900. In this embodiment, the processing unit 10 is further configured to receive the GPS signal from the antenna unit 15, and to perform a comparison computation upon the GPS signal and the map data 121 stored in the storage unit 12 to acquire a current position of the vehicle 5. The processing unit 10 is further configured to generate a detection signal when the current position is located on or adjacent to at least one road. The at least one road may be an accident-prone road or a road where a speed limit is easily exceeded. Moreover, the detection signal may be generated when the current position is located at or adjacent to an intersection. From the pre-stored table 122 of the storage unit 12, the processing unit 10 is operable to acquire one of the vehicle driving conditions that matches with the generated detection signal. Then, the processing unit 10 is operable to activate the recording of the traffic images of the image capturing unit 13 at the second recording frame rate when the acquired vehicle driving condition corresponds to an alert condition.

The processor unit 10 is configured to control the display unit 16 to display the traffic images captured by the image capturing unit 13.

Some of the effects and technical features of the drive recorder system 100 will now be described in the following paragraphs:

1. When the vehicle 5 is in an alert driving condition, the recording frame rate is increased. In detail, the processing unit 10 is operable to receive the motion value from the motion sensing unit 14 and to perform motion detection computation upon the motion value to obtain a computed detection signal. From the pre-stored table 122, the processing unit 10 acquires one of the vehicle driving conditions that matches with the computed detection signal. The processing unit 10 is then operable to activate the recording of the traffic images at the higher recording frame rate when the acquired vehicle driving condition corresponds to an alert condition (such as an abnormal driving condition).

2. When the vehicle 5 is not moving, recording of the traffic images may be deactivated to conserve power. In detail, when the motion value is lower than a minimum value for a first predetermined period of time, the processing unit 10 is operable to send the power off signal to the power supply unit 11, and the power supply unit 11 responds to the power off signal by cutting off supply of electric power for deactivating the recording of the traffic images by the image capturing unit 13. On the other hand, when the motion value is higher than the minimum value for a second predetermined period of time, the processing unit 10 is operable to send the power on signal to the power supply unit 11, and the power supply unit 11 responds to the power on signal by resuming supply of electric power for activating the recording of the traffic images by the image capturing unit 13.

3. When the vehicle 5 is on an alert road condition, the recording frame rate is increased. In detail, the processing unit 10 is configured to receive the GPS signal from the antenna unit 15 and to perform a comparison computation upon the GPS signal and the map data 121 stored in the storage unit 12 to acquire a current position. The processing unit 10 is then operable to generate a detection signal when the current position is located on or adjacent to an accident-prone road or a road where a speed limit is easily exceeded, or when the current position is located at or adjacent to an intersection. From the pre-stored table 122, the processing unit 10 is operable to acquire one of the vehicle driving conditions that matches with the generated detection signal, and to activate the recording of the traffic images at the higher recording frame rate when the acquired vehicle driving condition corresponds to an alert condition (i.e., the current position corresponds to an intersection, an accident-prone road, or a road where a speed limit is easily exceeded).

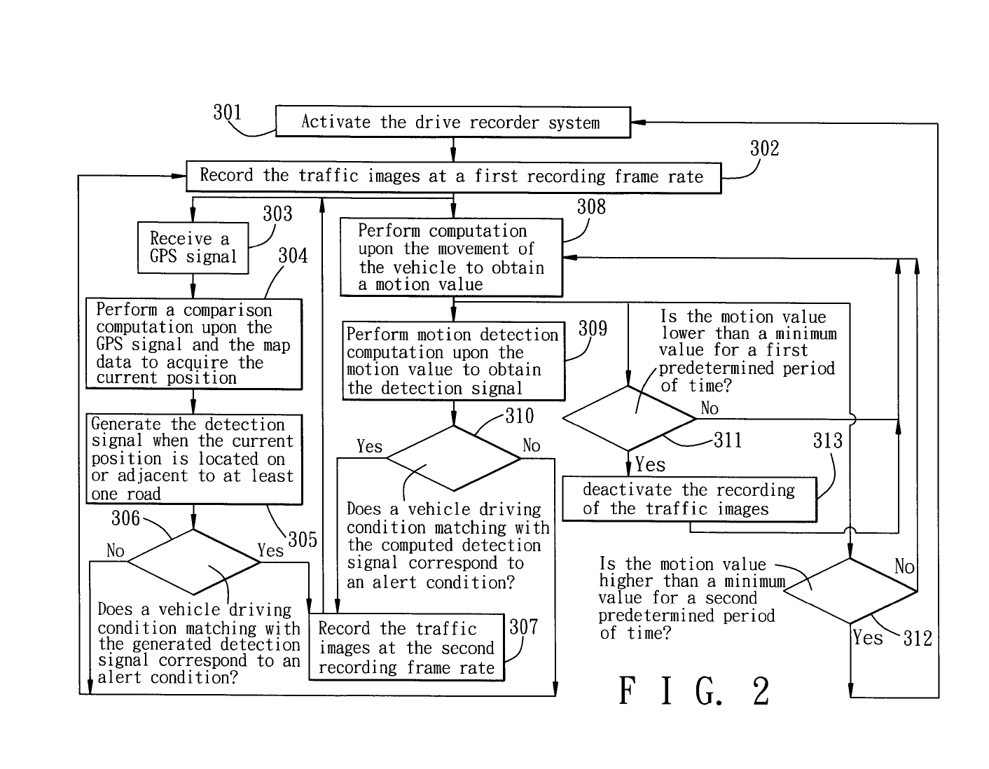

Referring to FIG. 2, a method of recording traffic images implemented in the drive recorder system 100 comprises the following steps.

In step 301, the drive recorder system 100 is switched from a deactivated state to an activated state.

In step 302, the drive recorder system 100 is operable to record the traffic images at a first recording frame rate. The flow then proceeds to steps 303 and 308.

When the current position of the vehicle 5 corresponds to an intersection, an accident-prone road, or a road where a speed limit is easily exceeded, the drive recorder system 100 is operable to generate a detection signal based on a GPS signal.

In step 303, the drive recorder system 100 is operable to receive a GPS signal.

In step 304, the drive recorder system 100 is operable to perform a comparison computation upon the GPS signal and the map data 121 to acquire the current position.

In step 305, the drive recorder system 100 is operable to generate the detection signal when the current position is located on or adjacent to at least one road.

In step 306, the drive recorder system 100 is operable to determine whether a vehicle driving condition that matches with the generated detection signal corresponds to an alert condition (i.e., the current position corresponds to an intersection, an accident-prone road, or a road where a speed limit is easily exceeded). If affirmative, the drive recorder system 100 is operable to activate the recording of the traffic images at the second recording frame rate. Otherwise, the flow goes back to step 302.

The drive recorder system 100 is further operable to generate a detection signal according to movement of the vehicle 5.

In step 308, the drive recorder system 100 is operable to perform computation upon the movement of the vehicle 5 to obtain a motion value.

In step 309, the drive recorder system 100 is operable to perform motion detection computation upon the motion value to obtain the detection signal.

In step 310, the drive recorder system 100 is operable to determine whether a vehicle driving condition that matches with the computed detection signal corresponds to an alert condition (i.e., a dangerous driving action). If affirmative, the flow goes to step 307. Otherwise, the flow goes back to step 302.

Moreover, according to the motion value, the drive recorder system 100 is further operable to deactivate or activate the recording of the traffic images by the image capturing unit 13 to conserve power.

In step 311, the drive recorder system 100 is operable to determine whether the motion value is lower than a minimum value for a first predetermined period of time. If affirmative, the flow goes to step 313.

In step 313, the drive recorder system 100 is operable to deactivate the recording of the traffic images. The flow then goes back to step 308.

In step 312, the drive recorder system 100 is operable to determine whether the motion value is higher than the minimum value for a second predetermined period of time. If affirmative, the flow goes to step 301. Otherwise, the flow goes back to step 308.

To sum up, in the drive recorder system 100 and method of recording traffic images of the present invention, the recording frame rate is increased when the vehicle driving condition corresponds to an alert condition so that a satisfactory reconstruction of a vehicular accident is possible.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of recording traffic images to be implemented in a drive recorder system, the method comprising:
recording the traffic images at a first recording frame rate;
generating a detection signal according to movement of the vehicle;
searching a pre-stored table to acquire a vehicle driving condition matching with the detection signal; and
recording the traffic images at a second recording frame rate when the acquired vehicle driving condition corresponds to an alert condition, wherein the second recording frame rate is greater than the first recording frame rate.

2. The method as claimed in claim 1, wherein the step of generating the detection signal includes:
performing computation upon the movement of the vehicle to obtain a motion value; and
performing motion detection computation upon the motion value to obtain the detection signal.

3. The method as claimed in claim 2, further comprising the step of:
deactivating the recording of the traffic images by the drive recorder system when the motion value is lower than a minimum value for a first predetermined period of time.

4. The method as claimed in claim 3, further comprising the step of:
activating the recording of the traffic images by the drive recorder system when the motion value is higher than the minimum value for a second predetermined period of time.

5. The method as claimed in claim 1, wherein the step of generating the detection signal includes:
receiving a global positioning system (GPS) signal; and
performing a comparison computation upon the GPS signal to obtain the detection signal.

6. The method as claimed in claim 5, wherein the step of performing the comparison computation upon the GPS signal includes:
performing the comparison computation upon the GPS signal and map data to acquire a current position; and
generating the detection signal when the current position is located on or adjacent to at least one road.

7. The method as claimed in claim 6, wherein the at least one road is an accident-prone road or a road where a speed limit is easily exceeded.

8. The method as claimed in claim 5, wherein the step of performing the comparison computation upon the GPS signal includes:
performing the comparison computation upon the GPS signal and map data to acquire a current position; and
generating the detection signal when the current position is located at or adjacent to an intersection.

9. A drive recorder system for use in a vehicle, comprising:
an image capturing unit configured to record traffic images at a first recording frame rate when the drive recorder system is switched from a deactivated state to an activated state;
a motion sensing unit for generating a motion value according to movement of the vehicle;
a storage unit for storing a pre-stored table that defines relationships between a plurality of detection signals and a plurality of vehicle driving conditions that respectively match with the detection signals; and
a processing unit coupled electrically to said image capturing unit, said motion sensing unit, and said storage unit;
said processing unit being configured to receive the motion value from said motion sensing unit, to perform motion detection computation upon the motion value to obtain a computed detection signal, to acquire, from the pre-stored table, one of said vehicle driving conditions that matches with the computed detection signal, and to activate the recording of the traffic images at a second recording frame rate when the acquired vehicle driving condition corresponds to an alert condition, wherein the second recording frame rate is greater than the first recording frame rate.

10. The drive recorder system as claimed in claim 9, further comprising a power supply unit coupled electrically to said processing unit,
wherein, when the motion value is lower than a minimum value for a first predetermined period of time, said processing unit is operable to send a power off signal to said power supply unit, and said power supply unit is responsive to the power off signal to cut-off supply of electric power for deactivating the recording of the traffic images by said image capturing unit.

11. The drive recorder system as claimed in claim 10, wherein, when the motion value is higher than the minimum value for a second predetermined period of time, said processing unit is operable to send a power on signal to said power supply unit, and said power supply unit is responsive to the power on signal to resume supply of electric power for activating the recording of the traffic images by said image capturing unit.

12. A drive recorder system for use in a vehicle, comprising:
an image capturing unit configured to record traffic images at a first recording frame rate when the drive recorder system is switched from a deactivated state to an activated state;
an antenna unit operable to receive a global positioning system (GPS) signal;
a storage unit for storing a pre-stored table that defines relationships between a plurality of detection signals and a plurality of vehicle driving conditions that respectively match with the detection signals, said storage unit further storing map data; and
a processing unit coupled electrically to said image capturing unit, said antenna unit, and said storage unit;
said processing unit being configured to receive the GPS signal from said antenna unit, to perform a comparison computation upon the GPS signal and the map data stored in said storage unit to acquire a current position, to generate a detection signal when the current position is located on or adjacent to at least one road, to acquire, from said pre-stored table, one of said vehicle driving conditions that matches with the generated detection signal, and to activate the recording of the traffic images at a second recording frame rate when the acquired vehicle driving condition corresponds to an alert condition, wherein the second recording frame rate is greater than the first recording frame rate.

13. The drive recorder system as claimed in claim 12, wherein the at least one road is an accident-prone road or a road where a speed limit is easily exceeded.

14. The drive recorder system as claimed in claim 12, wherein the detection signal is generated when the current position is located at or adjacent to an intersection.
